(19) United States
(12) Patent Application Publication
(10) Pub. No.: US 2019/0009652 A1
(43) Pub. Date: Jan. 10, 2019

(54) Window Insert Device

(71) Applicant: Marlow Stallworth, Cincinnati, OH (US)

(72) Inventor: Marlow Stallworth, Cincinnati, OH (US)

(21) Appl. No.: 15/644,893

(22) Filed: Jul. 10, 2017

(51) Int. Cl. B60J 1/20; E06B 3/32; E06B 7/03

(52) U.S. Cl. CPC B60J 1/20; B60J 7/00; E06B 7/03; E06B 3/32

(57) ABSTRACT

A window insert device for providing ventilation into a vehicle and a barrier to prevent a dog from exiting the vehicle through an open window. The window insert device includes a pair of vertical telescopic rods each having an upper end and a lower end. The first rod is parallel to the second rod, wherein the rods are disposed on opposite sides of a window frame. The ends of each rod include a male bracket that removably secures the device to the interior perimeter of a window frame of the vehicle. The device further includes a mesh panel disposed between the pair of rods so as to provide a barrier and ventilation for a dog. The mesh panel includes an opening so that a dog can insert its head therethrough. In this way, a dog's head can be placed through a vehicle window without having the ability to exit therethrough.

### BACKGROUND OF THE INVENTION

The present invention relates to window insert devices. More specifically, the present invention provides a pair of vertical telescopic rods, wherein a mesh panel is attached therebetween having an opening so that a dog can insert its head therethrough. The first rod is parallel to the second rod, wherein the rods are adapted to be disposed on opposing sides of a window frame of a vehicle. The ends of each rod include a male bracket adapted to removably secure the device to the interior perimeter of a window frame of the vehicle.

Dog owners and caretakers often travel with their dogs in a vehicle. Dog owners may travel with their dogs in order to take their dog to the veterinarian, to a park, or the dog owner may travel with the dog for leisure. These individuals may choose to drive with a window partially open so as to enjoy the weather outside and allow the dog to do the same. When a vehicle window is open, many dogs will place their head, front paws, or even a majority of their body through the window. This can be extremely dangerous because a dog can fall out of the vehicle or jump out of the open window, regardless if the vehicle is moving or parked. If a dog jumps out of a moving vehicle, the dog is likely to be hit by another vehicle or injured when landing outside of the vehicle. Additionally, a dog jumping out of a vehicle can cause an accident due to other drivers in the proximity swerving to avoid hitting the dog. In addition to the safety risk to the animal and other vehicles, it can cause frustration and anxiety to the pet owner or caretaker who have to then retrieve the dog.

Dog owners may enjoy the companionship when driving, however, are unable to take the dog into many stores. Furthermore, leaving a dog tethered to an object outside of a store is risky. An individual may take the dog if left unattended or the dog may attack a stranger who attempts to pet it. A safer option is to allow the dog can remain in the vehicle. However, the vehicle may be too hot and stuffy with all the windows closed. Therefore, there is a need for a device that provides a barrier to prevent a dog from jumping out of an open window and that provides adequate ventilation, while still allowing a dog to place its head though an open window.

Devices have been disclosed in the prior art that relate to window insert devices. These include devices that have been patented and published in patent application publications. These devices generally relate to panels adapted to fit in the window frame of a vehicle that allow air to flow therethrough while preventing an animal in the vehicle from jumping out of the open window. However, these devices fail to disclose a pair of vertical telescopic rods and a male bracket adapted to removably attach the device to the interior perimeter of a window frame of a vehicle. Additionally, these devices fail to disclose a mesh panel having an opening therein adapted to receive a dog's head therethrough.

In light of the devices disclosed in the prior art, it is submitted that the present invention substantially diverges in design elements from the prior art and consequently it is clear that there is a need in the art for an improvement to existing window insert devices. In this regard the instant invention substantially fulfills these needs.

### SUMMARY OF THE INVENTION

In view of the foregoing disadvantages inherent in the known types of window insert devices now present in the prior art, the present invention provides a new window insert device wherein the same can be utilized for providing convenience for the user when traveling with a dog in a vehicle with a window open.

It is therefore an object of the present invention to provide a new and improved window insert device that has all of the advantages of the prior art and none of the disadvantages.

It is another object of the present invention to provide a window insert device comprising a pair of parallel, vertical telescopic rods, wherein the rods include a locking mechanism and are adapted to be disposed on opposing sides of the interior perimeter of a window frame of a vehicle.

Another object of the present invention is to provide a window insert device further comprising a mesh panel disposed between a pair of telescopic rods, wherein the panel includes an opening adapted to receive a dog's head therethrough.

Another object of the present invention is to provide a window insert device wherein the ends of each rod include a male bracket adapted to removably secure the device to the lower slot and upper groove disposed on a window frame of the vehicle.

Another object of the present invention is to provide a window insert device that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the window insert device.

FIG. 2 shows a cross sectional view of the male bracket and the telescopic rod of the window insert device.

FIG. 3 shows a perspective view of an embodiment of the window insert device in use.

FIG. 4 shows an exploded view of an alternate embodiment of the window insert device.

FIG. 5 shows a perspective view of an alternate embodiment of the window insert device.

### DETAILED DESCRIPTION OF THE INVENTION

Reference is made herein to the attached drawings. Like reference numerals are used throughout the drawings to depict like or similar elements of the window insert device. For the purposes of presenting a brief and clear description of the present invention, the preferred embodiment will be discussed as used for traveling with a dog in a vehicle with a window open. The figures are intended for representative purposes only and should not be considered to be limiting in any respect.

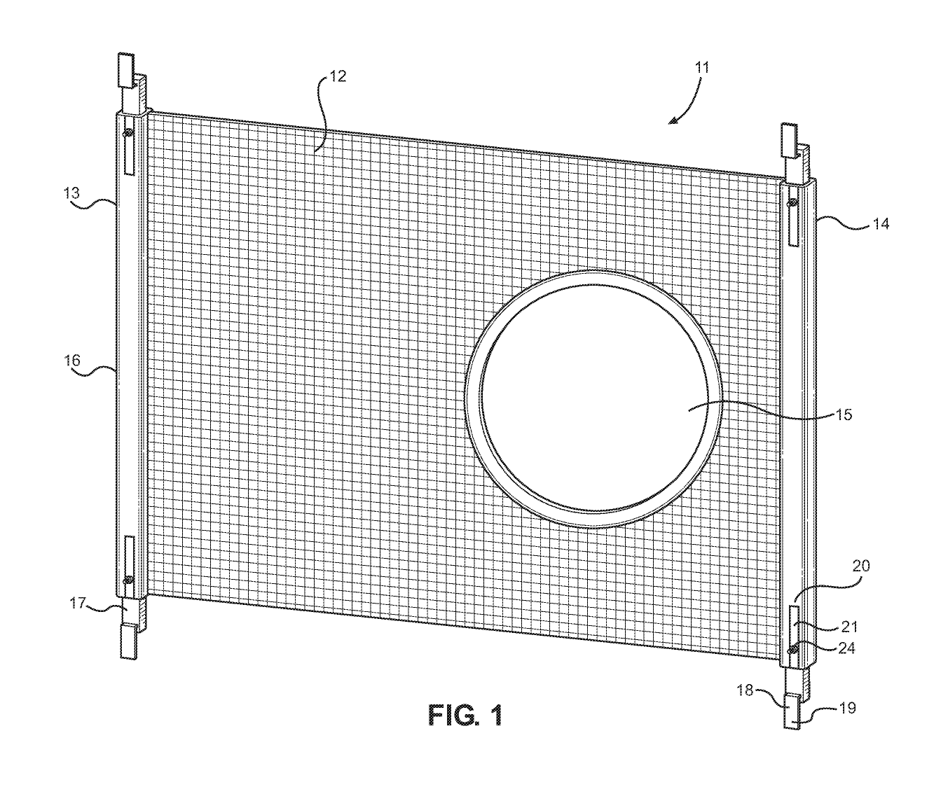

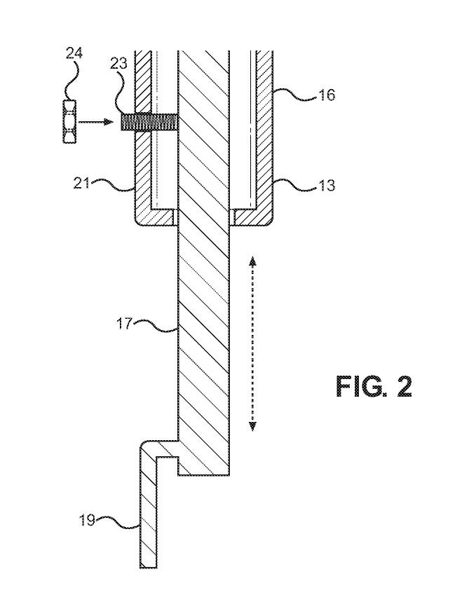

Referring now to FIGS. 1 and 2, there is shown a perspective view of an embodiment of the window insert device and a cross sectional view of the male bracket and the telescopic rod of the window insert device, respectively. The window insert device 11 comprises a first vertical telescopic rod 13 and a second vertical telescopic rod 14, wherein the rods 13, 14 are identical. The window insert device further includes a panel 12 adapted to provide a barrier to prevent a dog from exiting the vehicle through the open window and to provide ventilation for the dog while in the vehicle. The panel 12 is disposed between the first rod 13 and second rod 14. The panel 12 is rectangular in configuration and is flat. The vertical edges of the panel attach along the length of the rods 13, 14 by any suitable fastener, such as adhesive or clips. In some embodiments, the panel 12 is removably attached to the rods 13, 14. In this way, the vertical edges of the panel 12 comprise an elongated, fabric tube adapted to be placed over the rod 13. Therefore, the panel 12 removably attaches to the rods 13, 14 by slipping the fabric tubes onto the rods 13, 14.

In the illustrated embodiment, the panel 12 is composed of mesh. The mesh material provides ventilation by allowing air to flow therethrough. The mesh material is flexible and light-weight, allowing the device 11 to be easily stored and transported. The panel 12 includes an opening 15 so that a dog can insert its head therethrough. The opening 15 is preferably sized such that it of a size that allows a dog to insert its head therethrough, but that prevents the dog's body from passing therethrough. The opening 15 is preferably positioned in the panel 12 towards the second vertical rod 14, wherein the second vertical rod 14 is adapted to be positioned closer to the rear of the vehicle when the device is positioned within a vehicle window. Typically, a seat or bench in a vehicle is disposed towards the rear of the vehicle in reference to the seat's window. In this way, a dog can comfortably place his head through the opening 15 of the panel 12 while remaining on the seat. In some embodiments, the panel 12 comprises multiple openings 15 adapted to for multiple dogs to place their heads therethrough.

The telescopic rods 13, 14 are elongated and rectangular in shape with a square cross section. In some embodiments, the rods 13, 14 can be other suitable configurations, such as circular. A telescopic rod 13 comprises an outer shaft 16, a first inner shaft 17 and a second inner shaft 17, wherein the inner shafts 17 are adjustably positioned within the outer shaft 16 and can be secured in a desired position relative to the outer shaft 16 via a locking mechanism 20. This allows the overall length of the rod 13 to be adjustable and statically securable when in operation. The telescopic rod 13 is adjusted and vertical tension is maintained via the locking mechanism 20. In the illustrated embodiment, the locking mechanism 20 is disposed on the side of the rod 13 that is perpendicular to the side that comprises the attachment of the panel 12. However, the locking mechanism 20 can be deposed on any side of a rod 13, except where the panel attaches thereto due to the limited surface space available to place the locking mechanism 20 thereon.

In the illustrated embodiment, the upper end and lower end of each telescopic rod 13, 14 comprise a locking mechanism 20. In this way, the upper end and lower end of the rods 13, 14 are adapted to be independently adjusted to fit within a window frame that is irregular in shape, wherein irregular means non-parallel surfaces. Each locking mechanism 20 comprises a screw 23 and nut 24 assembled along a vertical slot disposed in the lower and upper ends of each rod 13, 14. The screw 23 is perpendicularly attached to the inner shaft 17 and extends outwardly therefrom, wherein the screw 23 aligns with and fits through the vertical slot 21 of the outer shaft 16. The dimension of the nut 24 is larger than the slot 21. Therefore, when the nut 24 is tightened onto the screw 21, the telescopic rod 13 is locked. In some embodiments, other suitable locking mechanisms 20 can be included, such as a clamp disposed at the interface of the outer 16 and inner 17 shafts of the rod 13.

The ends of each rod 13, 14 include a male bracket 18 adapted to interlock with a window slot disposed at the base of the window frame and a groove disposed in the upper end of the window frame. A male bracket 18 can include a bracket or fastener with an elongated piece adapted to fit within a slot or groove. In the illustrated embodiment, the male fastener 18 is an L-shaped hook 19. The L-shaped hook 19 is removably attached to a window frame in order to provide further securement against forces applied perpendicularly to the vertical plane of the window. The male bracket 18 and rod 13 can be composed as one piece or attached by any suitable fastener, such as a screw or adhesive. Together, the telescopic rod 13, along with the L-shaped hook 19, allow the device to removably attach to the interior perimeter of a window frame.

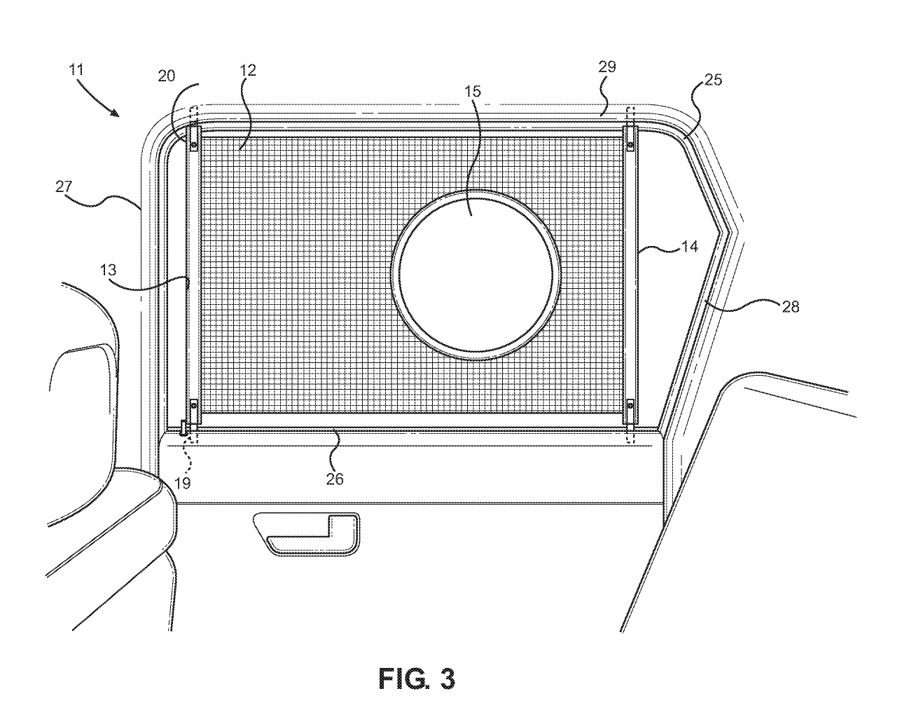

Referring now to FIG. 3, there is shown a perspective view of an embodiment of the window insert device in use. The window insert device 11 is adapted to be disposed in the interior perimeter of a window frame 25 of an open window. The L-shaped hooks 19 disposed on the lower ends of the first and second vertical telescopic rods 13, 14 are adapted to be placed in the slot 26 of the lower end of the interior perimeter of the window frame 25. The L-shaped hooks 19 disposed on the upper ends of the first and second vertical telescopic rods 13, 14 are adapted to be placed in the groove 29 of the upper end of the interior perimeter of the window frame 25. The telescopic rods 13, 14 are disposed on opposing sides 27, 28 of the window frame, whereby the mesh panel 12 is pulled taut therebetween.

The telescopic rods 13, 14 are secured in place by the locking mechanism 20. In this way, pressure from a telescopic rod 13 applied against the open window frame 25 provides force to maintain the position of the device 11. The L-shaped hooks 19 provide further securement needed while the vehicle is moving or in the event a dog applies force to the panel 12. The L-shaped hooks 19 allow the window to remain completely open while the device 11 is installed. With the device 11 installed, a dog is able to place its head through the opening 15 from inside the vehicle. The opening 15 is preferably sized such that it of a size that allows a dog to insert its head therethrough, but that prevents the dog's body from passing therethrough. In this way, the dog is provided with fresh air within a parked or moving vehicle, without the ability for the dog to exit through the open window.

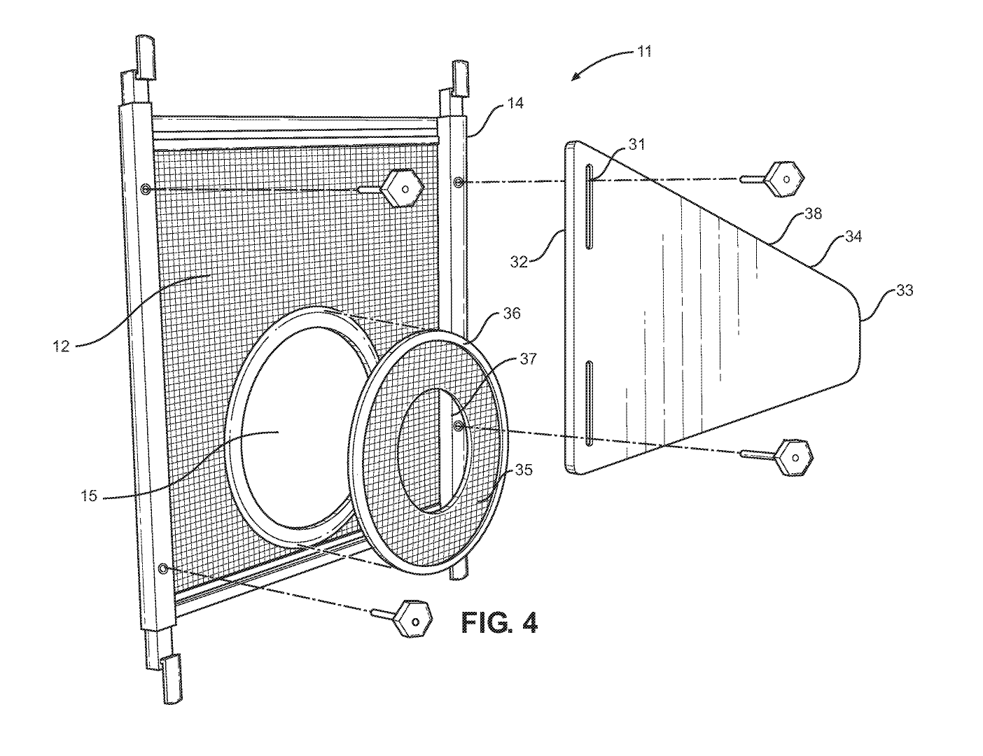

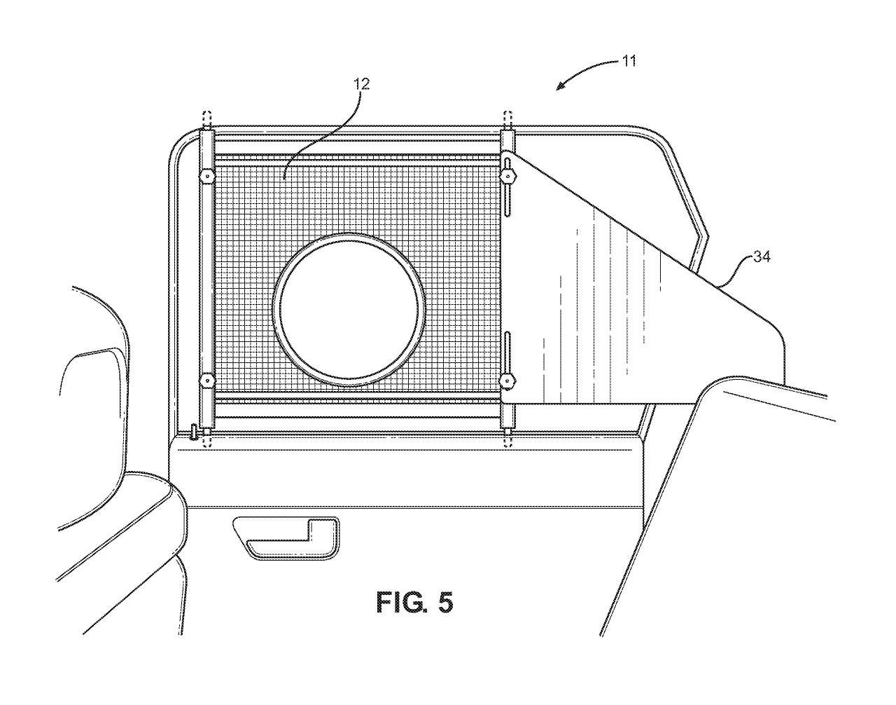

Referring now to FIGS. 4 and 5, there is shown an exploded view of an alternate embodiment of the window insert device and a perspective view of an alternate embodiment of the window insert device, respectively. In the illustrated alternate embodiment, the window insert device 11 comprises an opening cover 35 adapted to fit within the opening 15 so as to form a second opening 37, wherein the second opening 37 includes a smaller diameter than the opening 15 in the panel 12. In this way, a user can selectively adjust the size of the opening within the panel 12. The second opening 37 is centrally positioned on the opening cover 37. The opening cover 35 comprises substantially the same diameter as the opening 15 such that the opening cover 35 fits flush therein. In the illustrated embodiment, the perimeter of the opening cover 35 comprises a lip 36 configured to removably secure via a snap-like function to the perimeter of the opening 15 such that the mesh portions of the panel 12 and the opening cover 35 align along the same plane when secured to one another.

The alternative embodiment of the window insert device 11 further comprises a side panel 34 removably securable to a rod 14. The side panel 34 is configured to cover a window portion that the panel 12 is unable to cover such as to allow the window insert device 11 to be used with vehicles having different sized and shaped windows. A first side 32 of the side panel 34 comprises at least one aperture 31 adapted to align with at least one aperture disposed on the rod 14. A fastener, such as a screw, can be placed through both apertures 31, thereby securing the side panel 34 to the rod 14. In the illustrated embodiment, the side panel comprises a pair of apertures 31 that align with the slots disposed on the rod 14. In the illustrated embodiment, the first side 32 of the side panel 34 comprises the same height as the height of the panel 12 and tapers toward the opposing second side 33 via a sloped upper end 34.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A window insert device, comprising:
a first rod and a second rod each having an upper end and a lower end, wherein said first rod is parallel to said second rod, wherein said first rod and second rod are adapted to be disposed within a window frame of a vehicle;
wherein said first rod and said second rod are telescopic;
a panel having an opening adapted to receive a dog's head therethrough;
wherein said panel extends between said first rod and said second rod;
wherein said upper end and said lower end of said first rod and said upper end and said lower end of said second rod include a male bracket thereon adapted to removably attach said first rod and said second rod to said window frame of said vehicle.

2) The window insert device of claim 1, wherein said panel is composed of mesh.

3) The window insert device of claim 1, wherein said male bracket is an L-shaped hook.

4) The window insert device of claim 1, wherein said opening is circular in configuration.

5) The window insert device of claim 1, wherein said first rod and said second rod are rectangular in shape with a square cross section.

6) The window insert device of claim 1, wherein said first rod and said second rod each comprise an outer shaft, a first inner shaft, and a second inner shaft, wherein said first inner shaft and said second inner shaft are adjustably positioned within said outer shaft at opposing ends of said outer shaft, such that the length of said first rod and said second rod can be adjusted.

7) The window insert device of claim 6, further comprising a locking mechanism disposed on said upper end and said lower end of said first rod and said second rod adapted to adjustably secure a length of said first rod and said second rod.

8) The window insert device of claim 7, wherein said locking mechanism comprises a vertical slot disposed on an end of said outer shaft, a screw perpendicularly attached to an inner shaft and extending outward therefrom, and a nut, wherein said screw is adapted to align with and fit through said vertical slot of said outer shaft, wherein said inner shaft is locked in place by screwing said nut onto said screw.

9) The window insert device of claim 1, further comprising an opening cover having a second opening and a diameter with a same diameter as the opening.

10) The window insert device of claim 9, wherein the perimeter of the opening cover comprises a lip adapted to engage with the perimeter of the opening so as to removably secure the opening cover to the opening.

11) The window insert device of claim 1, further comprising a side panel removably securable to either the first rod or second rod.

12) The window insert device of claim 11, wherein the side panel comprises a first side having a same height as a height of the panel and tapers towards an opposing second side via a sloped upper end thereof.
